(19) United States
(12) Patent Application Publication
(10) Pub. No.: US 2024/0139655 A1
(43) Pub. Date: May 2, 2024

(54) CATCH BASIN INSERT STORMWATER FILTERING APPARATUS HAVING A PLANAR FRAME AND GEOTEXTILE FABRIC BASKET SUPPORTED THEREBY FOR DEBRIS AND TRASH CAPTURE

(71) Applicant: Fabco Industries Inc., Hauppauge, NY (US)

(72) Inventor: John Peters, Jr., Coram, NY (US)

(21) Appl. No.: 18/385,521

(22) Filed: Oct. 31, 2023

Related U.S. Application Data
(60) Provisional application No. 63/421,237, filed on Nov. 1, 2022.

(51) Int. Cl. B01D 29/23; B01D 39/08; E03F 1/00; E03F 5/14

(52) U.S. Cl. CPC B01D 29/23; B01D 39/083; E03F 1/005; E03F 5/14; B01D 2201/0415; B01D 2201/24; B01D 2239/0613

(57) ABSTRACT

A catch basin stormwater filtering apparatus includes a support frame and a filter medium supported by the support frame. The support frame includes a planar upper plate and a planar lower plate disposed below and in close proximity to the upper plate. The upper and lower plates have substantially the same outer dimensions, and the support frame defines a central opening. The filter medium is in the shape of a basket and includes lateral side walls of which adjacent walls are joined together, and a bottom wall, the lateral side walls defining a top opening which is disposed in alignment with the central opening of the support frame. The filter medium also includes a flange that extends outwardly from the lateral side walls at the top opening of the filter medium. The flange is interposed between and adhesively joined to the upper plate and the lower plate of the support frame.

### CROSS-REFERENCE TO RELATED APPLICATIONS

This application is related to U.S. Provisional Application Ser. No. 63/421,237, filed on Nov. 1, 2022, and titled “Catch Basin Insert Stormwater Filtering Apparatus Having a Planar Frame and Geotextile Fabric Basket Supported Thereby for Debris and Trash Capture”, the disclosure of which is incorporated herein by reference and on which priority is hereby claimed.

### BACKGROUND OF THE INVENTION

### Field of the Invention

The present invention generally relates to stormwater drainage systems, and more particularly relates to filtering apparatus used therewith.

### Description of the Prior Art

Stormwater drainage systems are commonly used in streets, highways, parking lots and other paved surfaces throughout the United States and in foreign countries, especially in urban developments, to remove water accumulating on the surfaces thereof. Most people would recognize the presence of such drainage systems from the heavy metal grates 2 mounted flush in parking lots or streets. Under the grate 2 is usually found a concrete, fiberglass or metal catch basin, or storm vault 4, which is connected to a conduit that channels the stormwater away from the area to a relatively large water collection reservoir, or to a river, stream or other body of water.

One typical storm vault 4 which is used in many municipalities is shown in FIGS. 1, 1A and 1B of the drawings. Such storm vaults 4 are usually made from concrete and are rectangular in transverse and longitudinal cross-sections, i.e., the vaults 4 are formed as a rectangular parallelepiped, with opposite front and rear side walls, opposite lateral side walls, a bottom wall and a top cover wall. The heavy steel grate 2 is removably supported by a cast iron or steel frame 5 of the storm vault 4, and rests on a horizontal ledge 7 of the cast frame 5. The walls of the storm vault 4 define an interior cavity which receives stormwater through the grate opening 6 defined by the metal frame 5, the vault 4 being positioned in the ground such that the grate opening 6, and the grate 2 received thereby, are flush with the surface of the paved roadway. The grate opening 6 receives through the grate 2 runoff water accumulating on the roadway, which water flows therethrough and into the internal cavity of the vault 4, where the water is directed to a channeling conduit forming part of the stormwater drainage system.

Many municipalities now require filtering apparatus to be placed inside the storm vault 4 or catch basin in order to filter coarse materials and debris, such as leaves, stones, branches and manmade trash, and fine material, such as sediment and sand, carried by stormwater that enters the storm vault 4 through the grate opening 6 formed therein and that collects within the internal cavity of the storm vault 4. Such coarse debris material and sediment may clog the drainage conduit connected to the storm vault 4 and may contribute to the pollution of the body of water to which the stormwater from the catch basin (storm vault) 4 collects.

One of the biggest challenges manufacturers and installers of such filtering apparatus face in providing storm drain protection is receiving a proper detailed measurement survey of the storm drain 4 to be fitted with a filtering apparatus. Storm drains 4 are hardly ever identical in dimensions. Even though storm drains 4 appear to be the same from the surface, there are typically many irregularities below the grate 2 that require close consideration on the part of stormwater filter manufacturers and installers. Typically, there are various forms of protrusions, such as pipes, bricks, concrete ledges, and others. All of these irregularities must be included in the measurement survey provided by the customer (e.g., the municipality's department of public works). Unfortunately, most drain surveys are provided to the manufacturer or installer by inexperienced workers who may not account in the survey for all irregularities which need to be accounted for in the design and placement of the filtering apparatus. All of this, and more, leads to a lot of time spent going back and forth with the customer to assure the filter unit will fit properly in the storm drain 4.

Fabco Industries Inc. of Farmingdale, New York, the applicant herein, has designed, sells and installs an innovative stormwater filtering apparatus known in the trade as the StormSack™ insert that includes an adjustable support frame for supporting a filter medium. The support frame is particularly constructed, and is adjustable in width and length, so as to fit under the steel grate 2 of an existing storm drainage basin, or storm vault 4, without significantly raising the elevation of the steel grate 2 under which the support frame and filter medium are situated. The support frame includes a rectangular, plate-like, planar main body surrounding a generally rectangular opening, and four generally Z-shaped support flanges mounted on the four sides of the rectangular main body for supporting the main body and the filter medium (e.g., a water-permeable sack or basket) attached thereto within the grate-covered opening 6 of the storm vault 4. The four flanges are adjustably mounted to the main body of the support frame on four sides thereof so that the support frame may be used with storm vaults 4 having a grate opening 6 that varies in lateral width and front-to-rear depth to some degree and to ensure a proper fit of the support frame within the grate openings 6. The frame supports the filter medium, which has a basket-like shape and is formed of a woven geotextile material, that hangs downwardly from the support frame and partially into the interior cavity of the storm vault 4.

The StormSack™ filter insert works exceedingly well in filtering debris carried by stormwater into the storm drain 4, and its adjustable support frame allows it to adapt to a certain degree to storm drains 4 of different dimensions. It adjusts to the size of the cast iron or steel frame ledge 7 that the grate 2 rests on, the dimensions of which are usually consistent with the manufacturers' catalog drawings, and there are few, if any, irregularities with these castings. The casting manufacturers appear to maintain relatively good quality control standards on which a manufacturer of stormwater filtering apparatus, such as the StormSack™ apparatus described previously, may rely.

The difficulties filter manufacturers and installers still often face when fitting a filter unit into a storm drain 4 is the concrete below the grate ledge casting 5. When building a road or parking lot, typically large precast storm drain structures are delivered and installed at the jobsite well before the road or lot is graded and paved. Since the asphalt or macadam is the last to go down, each storm drain frame 5 and grate 2 must be inspected, and many times shimmed to meet the new road surface. Oftentimes bricks, stones, cement blocks, troweled cement and other structural impediments to proper installation of an under-grate filter are used to bring the castings up to final grade to correctly meet the road surface. However, this work often results in irregular protrusions darting out from just under the castings. Also, pipe connections are typically performed on the jobsite and, depending on the pipe location, can interfere with filter installations.

Although the novel StormSack™ filter insert described previously rests on the grate ledge casting 5 of the storm drain 4, the general dimensions of the ledge 7 are required in selecting the properly sized filter support frame, which is adjustable to a certain degree, and the filter medium that will closely fit within the confines of the grate opening 6. Some storm drains 4 have grates 2 that are just too heavy for one person to lift, and require a team or special lifting equipment to remove in order to obtain more accurate storm drain measurements required by the stormwater filter manufacturer. However, the inventor herein has realized that such time-consuming and tedious measurements and surveys, including the lifting of the grates 2 to gain access to the interior dimensions of the grate ledge casting 5, can be avoided by simply measuring the outer dimensions of the grate 2 and tailoring a filtering apparatus with those grate dimensions. Since the grate 2 is supported by the ledge 7, so can a filtering apparatus having similar grate dimensions that is seated on the cast ledge 7 directly under the grate 2, with the weight of the grate 2 helping to maintain the filtering apparatus in place thereunder.

### OBJECTS AND SUMMARY OF THE INVENTION

It is an object of the present invention to provide a sediment and debris filtering apparatus that is fittable into an existing storm drainage basin.

It is another object of the present invention to provide a filtering apparatus having a frame and a filter medium supported thereby, the support frame being positionable under the steel grate of a storm vault without significantly raising the steel grate above the level of the paved surface under which the storm vault is installed.

Is it a further object of the present invention to provide a filtering apparatus having a support frame and filter medium for use in an existing storm drainage basin, which support frame and filter medium are easily removable therefrom for cleaning or replacement.

It is yet a further object of the present invention to provide a filtering apparatus having a support frame and filter medium for use with an existing storm drainage basin, the filtering apparatus being mechanically simple in structure and easily manufacturable.

It is still another object of the present invention to provide a filtering apparatus having a support frame and filter medium for use with an existing storm drainage basin, where the support frame has dimensions similar to or the same as those of the steel grate of the drainage basin.

In accordance with one form of the present invention, a filtering apparatus for use with an existing storm drain 4 includes a planar frame and a filter medium supported thereby. The support frame is particularly constructed so as to fit under the steel grate 2 of an existing storm drainage basin, or storm vault 4, without significantly raising the elevation of the steel grate 2 under which the support frame and filter medium are situated. The support frame is formed of upper and lower plates which define and surround a generally rectangular opening. The filter medium is preferably formed of a woven geotextile fabric and is preferably shaped as a basket and in the general form of a rectangular parallelepiped that is supported by the frame and which resides in the rectangular opening of the frame. The filter apparatus is situated in the grate opening 6 of the storm drain 4, with the support frame positioned to rest on the cast grate ledge 7 and under the steel grate 2. The fabric filter medium hangs downwardly from the support frame and partially into the interior cavity of the storm vault 4 within the grate-covered opening 6 thereof to collect sediment and debris carried by stormwater passing through the grate 2.

The fabric filter medium, preferably in the shape of a basket, includes lateral side walls and a bottom wall, all being joined together at corners where the walls meet. The fabric filter medium also includes an outwardly extending fabric lip or flange that is joined to and surrounds the side walls at the upper sections thereof and which is integrally formed as part of the side walls of the medium. The fabric lip or flange is sandwiched between the upper and lower plates of the support frame. Preferably, the sandwiched flange portion of the fabric filter medium, and the upper and lower plates of the support frame, are adhesively joined together to form an integral, unitary structure that has a minimal thickness so as not to significantly raise the height of the grate 2 relative to the surrounding paved roadway or surface.

The advantage of the design of the filtering apparatus of the present invention is the elimination of the need to take measurements of the grate ledge casting 5 or the drain opening 6. The concept is that if a customer (e.g., a municipality agency or department) provides the filter manufacturer or installer with the outer dimensions of just the top grate 2, which may be easily obtained and does not require the removal of the heavy steel grate 2, the manufacturer or installer can provide a filtering apparatus as disclosed herein with a support frame having dimensions which are substantially the same as those of the grate 2. Since the grate 2 obviously fits and rests on the support ledge 7 of the cast frame 5 of the catch basin 4, the filtering apparatus will also fit and rest on the same ledge 7.

These and other objects, features and advantages of the present invention will be apparent from the following detailed description of illustrative embodiments thereof, which is to be read in connection with the accompanying drawings.

### BRIEF DESCRIPTION OF THE DRAWINGS

FIG. 1 is a partially exploded, top perspective view of a stormwater drainage basin, or storm vault, for which the filtering apparatus of the present invention is adapted to be used.

FIG. 1A is a partially exploded, top perspective, longitudinal cross-sectional view the stormwater drainage basin, or storm vault, shown in FIG. 1 for which the filtering apparatus of the present invention is adapted to be used.

FIG. 1B is a partially exploded, longitudinal cross-sectional view of the upper section of the stormwater drainage basin, or storm vault, shown in FIG. 1A for which the filtering apparatus of the present invention is adapted to be used.

FIG. 2 is a partially exploded, top perspective view of a first form of a filtering apparatus constructed in accordance with the present invention.

FIG. 3 is a top plan view of the filtering apparatus of the present invention shown in FIG. 2.

FIG. 4 is a side perspective view of the filtering apparatus of the present invention shown in FIGS. 2 and 3.

FIG. 5 is a detailed, side perspective view of a portion of the filtering apparatus of the present invention shown encircled by the partially broken line labeled with reference numeral 1 in FIG. 4.

FIG. 6 is a partially exploded, top perspective view of a stormwater drainage basin, or storm vault, and the filtering apparatus of the present invention shown in FIGS. 2-5, and illustrating the placement of the filtering apparatus within the drainage basin.

FIG. 7 is a partially exploded, top perspective view of the upper section of the stormwater drainage basin, or storm vault, shown in FIG. 6 and the filtering apparatus of the present invention shown in FIGS. 2-6, and illustrating the placement of the filtering apparatus within the drainage basin.

FIG. 8 is another partially exploded, top perspective view of the upper section of the stormwater drainage basin, or storm vault, shown in FIGS. 6 and 7 and the filtering apparatus of the present invention shown in FIGS. 2-7, and illustrating the placement of the filtering apparatus within the drainage basin.

FIG. 9 is partially exploded, top perspective view of the upper section of the stormwater drainage basin, or storm vault, shown in FIGS. 6-8 and the filtering apparatus of the present invention shown in FIGS. 2-8, and illustrating the filtering apparatus situated within the drainage basin.

FIG. 10 is partially exploded, top perspective, longitudinal cross-sectional view of the upper section of the stormwater drainage basin, or storm vault, shown in FIGS. 6-9 and the filtering apparatus of the present invention shown in FIGS. 2-9, and illustrating the filtering apparatus situated within the drainage basin.

FIG. 11 is partially exploded, top perspective, longitudinal cross-sectional view of a portion of the upper section of the stormwater drainage basin, or storm vault, shown in FIGS. 6-10 and a portion of the filtering apparatus of the present invention shown in FIGS. 2-10, and illustrating the filtering apparatus situated within the drainage basin.

FIG. 12 is an exploded, top perspective view of the grate frame and grate of the stormwater drainage basin, or storm vault, shown in FIGS. 6-11 and the filtering apparatus of the present invention shown in FIGS. 2-11, and illustrating the placement of the filtering apparatus between the basin grate frame and grate.

FIG. 13 is a top perspective view of the grate frame of the stormwater drainage basin, or storm vault, shown in FIGS. 6-12 and the filtering apparatus of the present invention shown in FIGS. 2-12, and illustrating the placement of the filtering apparatus on the basin grate frame.

FIG. 14 is a top perspective, longitudinal cross-sectional view of a portion of the grate frame of the stormwater drainage basin, or storm vault, shown in FIGS. 6-14 and a portion of the filtering apparatus of the present invention shown in FIGS. 2-13, and illustrating the placement of the filtering apparatus on the basin grate frame.

FIG. 15 is a top perspective view of a second form of a filtering apparatus constructed in accordance with the present invention.

FIG. 16 is an exploded, top perspective view of a grate frame and grate of a stormwater drainage basin, or storm vault, and the filtering apparatus of the present invention shown in FIG. 15, and illustrating the placement of the filtering apparatus between the basin grate frame and grate.

FIG. 17 is a partially exploded, top perspective view of the grate frame and grate of a stormwater drainage basin, or storm vault, shown in FIG. 16 and the filtering apparatus of the present invention shown in FIGS. 15 and 16, and illustrating the placement of the filtering apparatus on the basin grate frame.

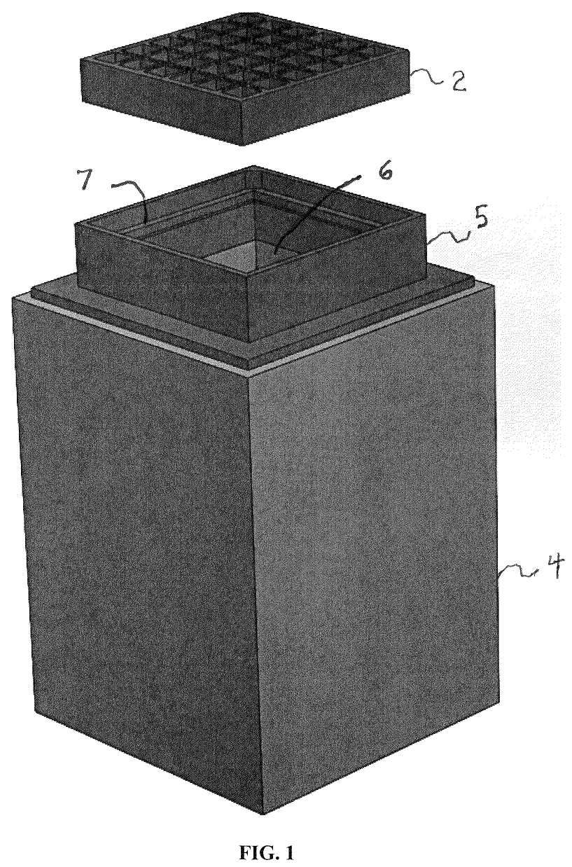

### DETAILED DESCRIPTION OF THE PREFERRED EMBODIMENTS

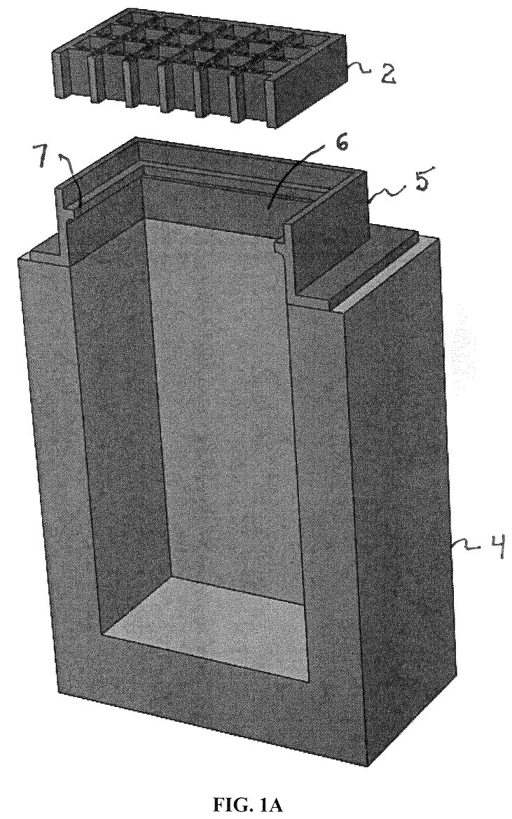

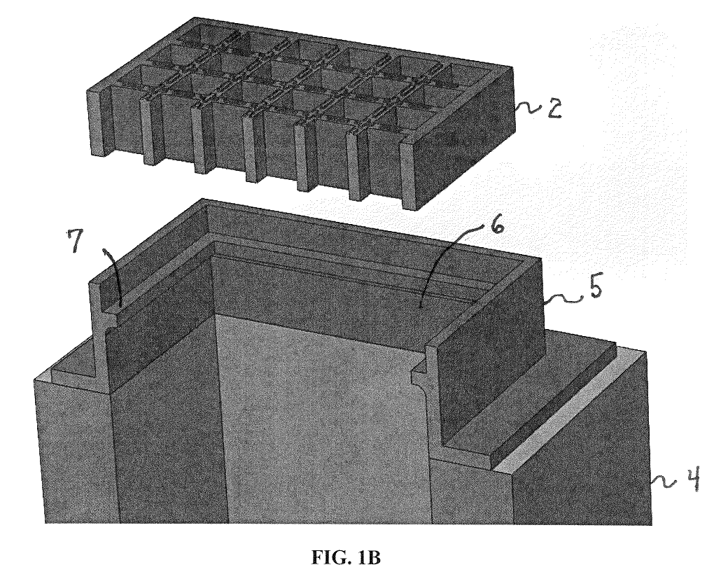

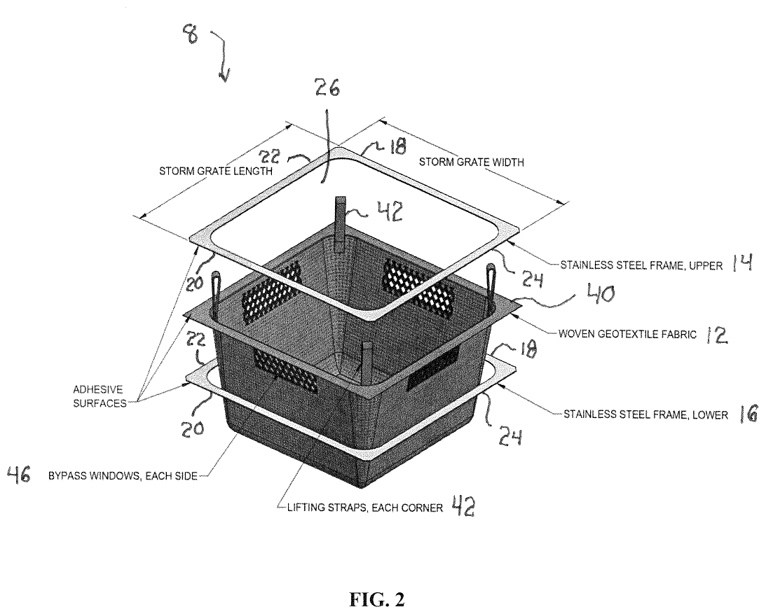

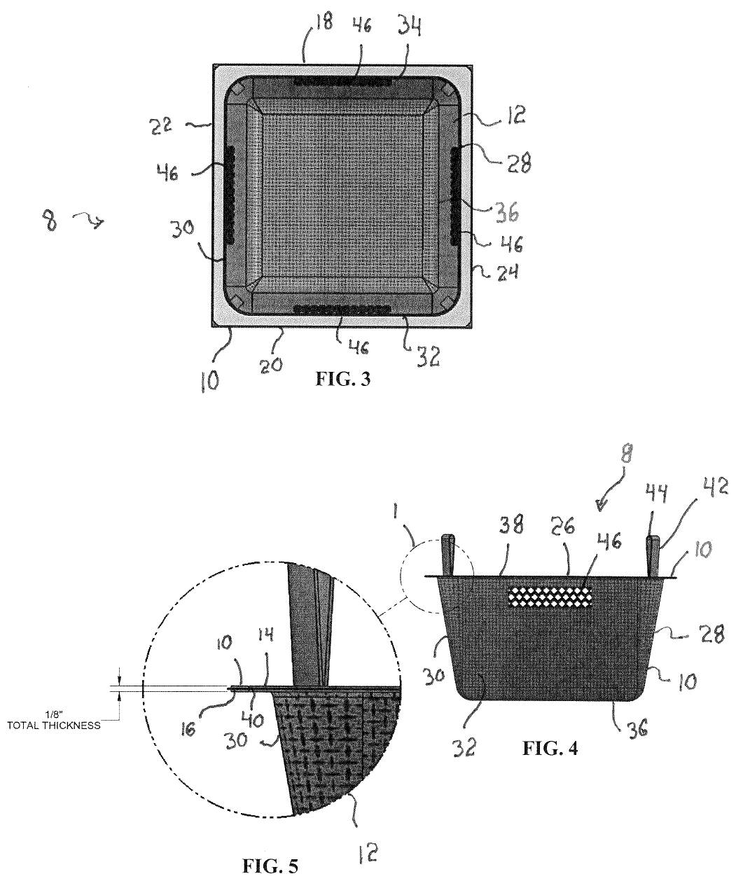

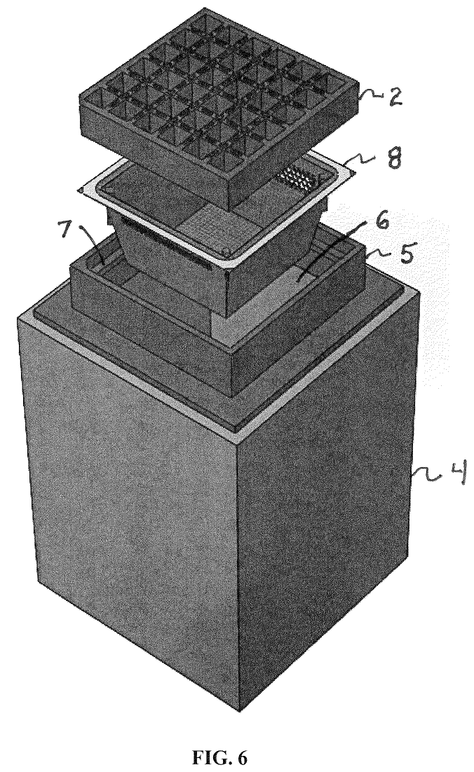

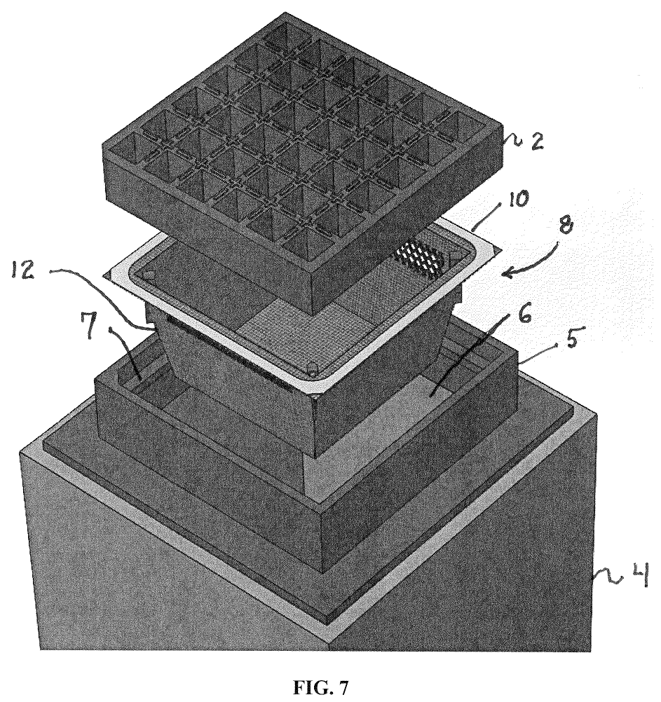

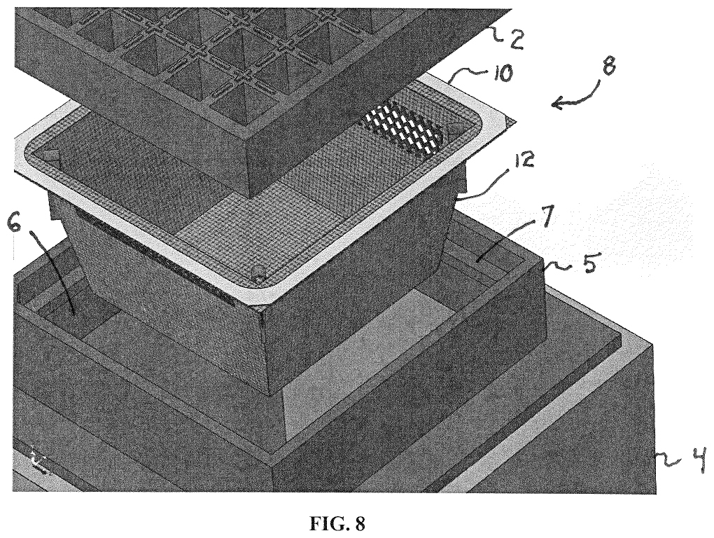

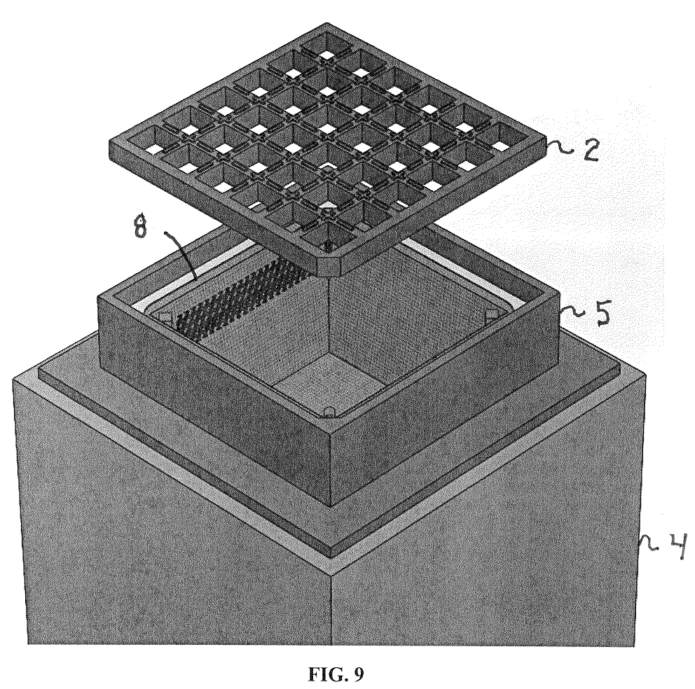

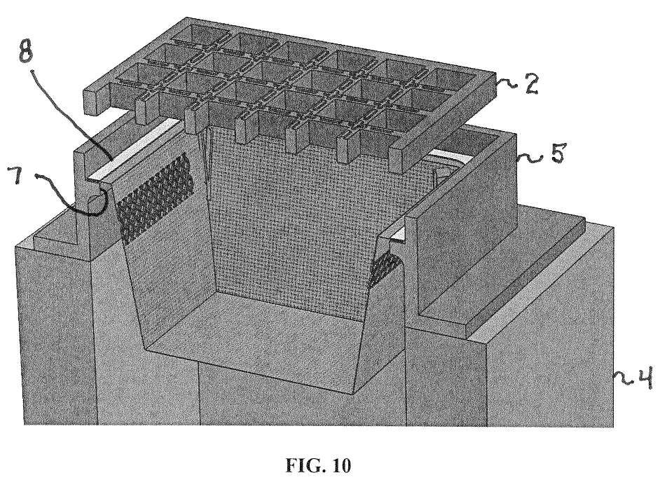

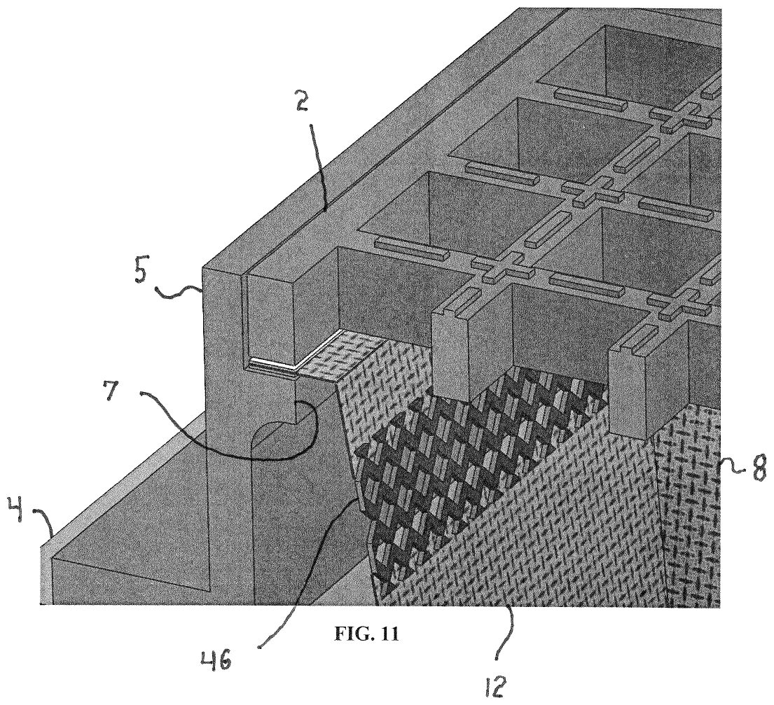

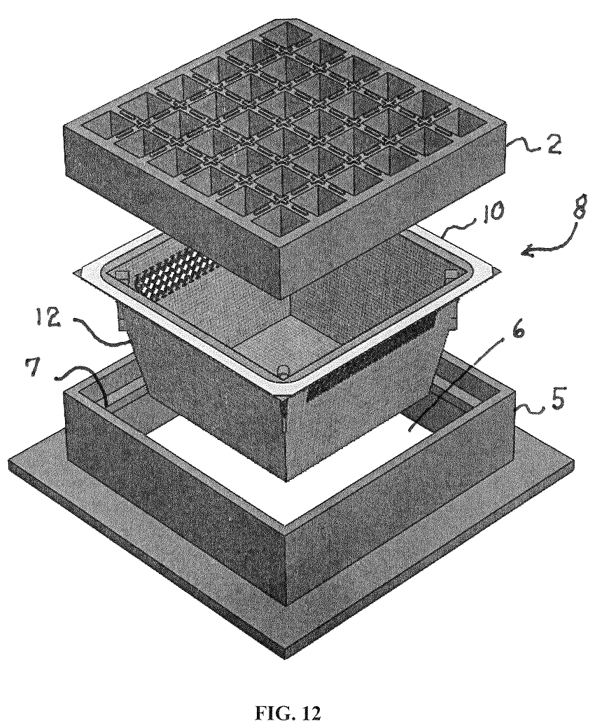

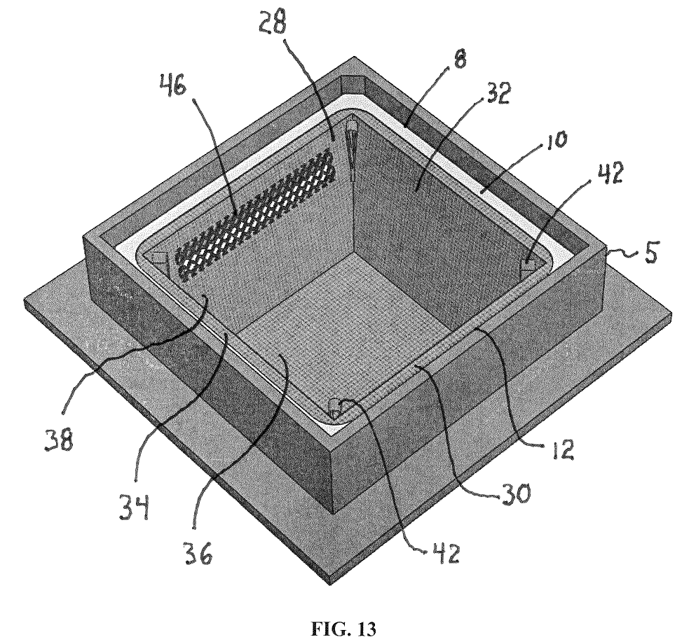

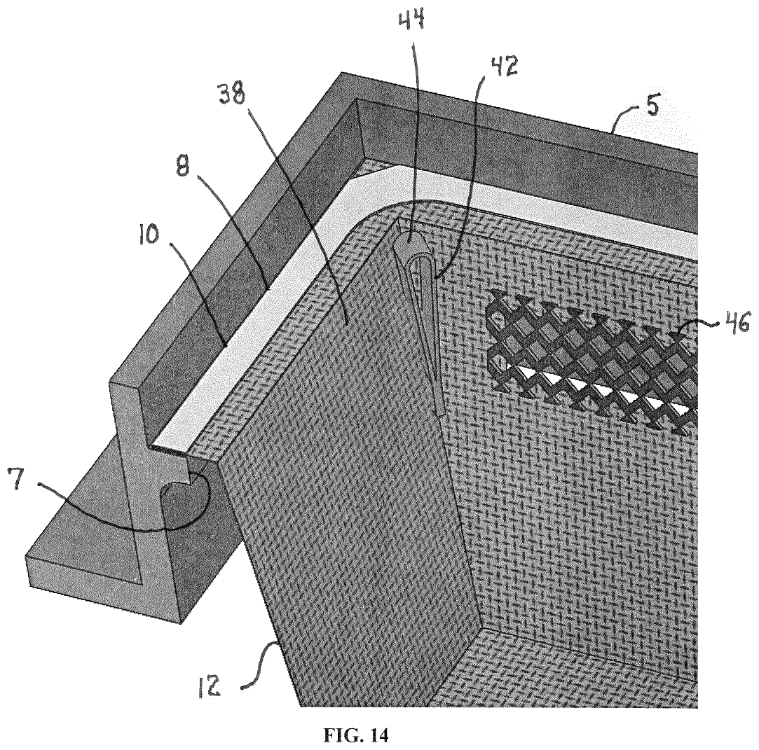

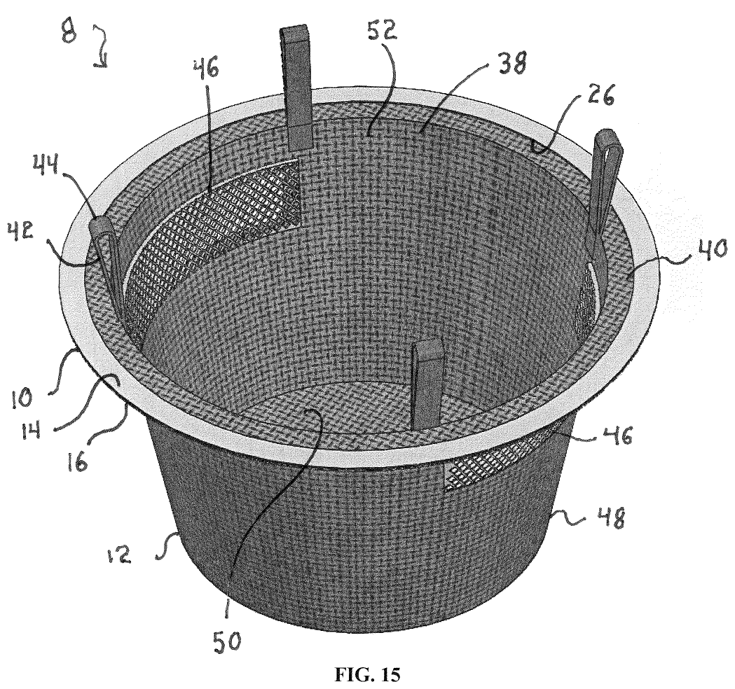

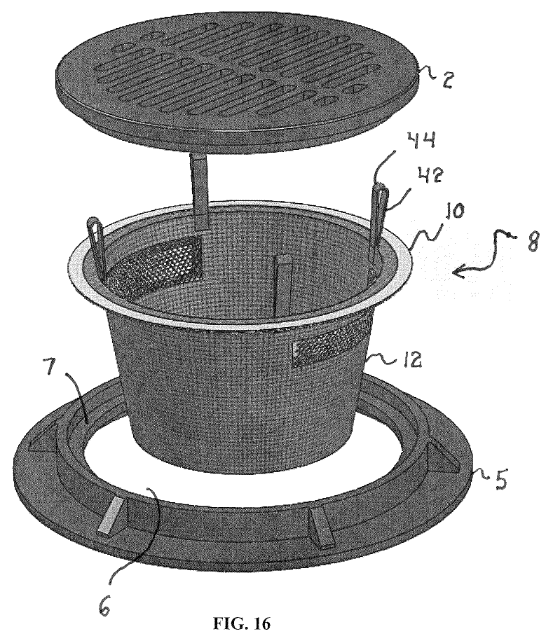

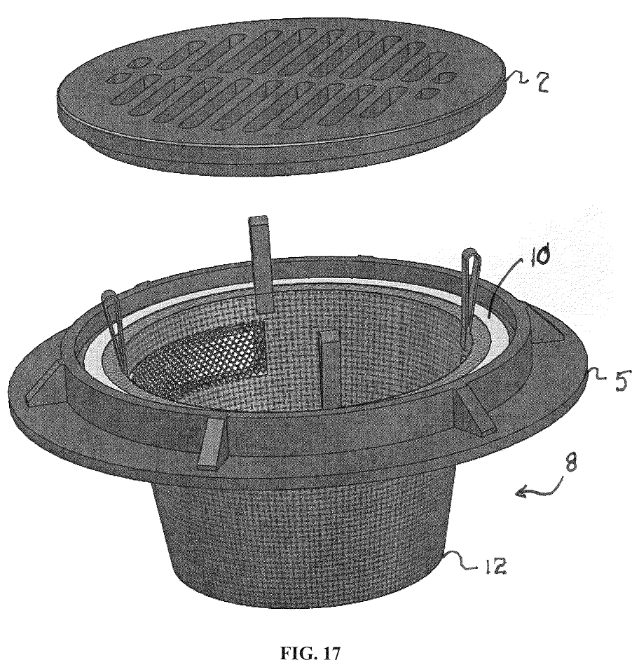

Referring initially to FIGS. 2-14 of the drawings, it will be seen that a first form of a filtering apparatus 8 constructed in accordance with the present invention includes a support frame 10 and a filter medium 12 supported thereby, the filtering apparatus 8 being receivable within the grate opening 6 and under the steel grate 2 of an existing storm drainage basin, or storm vault 4, without significantly raising the elevation of the steel grate 2. The support frame has a planar, generally rectangular, shape defined by a planar upper plate 14 and a planar lower plate 16 disposed below and in close proximity to the upper plate 14, the upper and lower plates 14, 16 of the support frame 10 being preferably formed from sheet metal, stainless steel or aluminum alloy and having the same or similar dimensions. Each of the upper plate 14 and the lower plate 16 of the support frame 10 includes opposite left and right lateral sides 18, 20 and opposite front and rear sides 22, 24, the left and right lateral sides 18, 20 of the upper plate 14 being joined to the front and rear sides 22, 24 of the upper plate 14 at right angles, and similarly, the left and right lateral sides 18, 20 of the lower plate 16 being joined to the front and rear sides 22, 24 of the lower plate 16 at right angles. Although in this first form of the filtering apparatus 8 of the present invention the support frame 10 is described and shown in FIGS. 2-14 of the drawings as having an overall rectangular shape, the support frame 10, and its upper and lower plates 14, 16, can take on other shapes, including circular, as shown in FIGS. 15-17 and which will be described in greater detail.

The support frame 10 defines a central opening 26, which is preferably rectangular but which could be circular, oval or another shape. As will be described below, the support frame 10, defined by the upper and lower plates 14, 16, supports a filter medium 12 preferably in the shape of a basket or possibly a cylindrical sack for catching sediment or debris carried by stormwater passing through the grate 2 of a storm drain 4. The filter medium 12 hangs below the support frame 10 in the rectangular opening 26 thereof, and is supported thereby.

The filter medium 12 is preferably formed from a woven geotextile fabric, such as Part No. GTF-117F, a 100% polypropylene fabric or yarn manufactured by several companies, such as U.S. Fabrics Inc. of Cincinnati, Ohio. The filter medium 12 is preferably in the shape of a rectangular parallelepiped, with four lateral side walls 28, 30, 32, 34 and a bottom wall 36, adjacent side walls 28-34 and the bottom wall 36 being joined together at their corners, and having a top opening 38. However, it is envisioned to be within the scope of the present invention to form the filter medium 12 from other materials and with other shapes, such as a cylindrically-shaped sack, or from other thermoplastic, water permeable materials.

To simplify its construction and connection to the support frame 10 of the filtering apparatus 8, the fabric filter medium 12 preferably includes an integrally formed fabric flange 40 which surrounds the four side walls 28-34 of the medium 12 at the upper portions thereof about the top opening 38 and extends outwardly therefrom. The flange 40 may be defined as outwardly extending flaps forming an extended upper section of each side wall 28-34. The flange 40 is received by, and is sandwiched between, the upper and lower plates 14, 16 of the support frame 10, with the top opening 38 of the filter medium 12 being situated in alignment with the central opening 26 of the support frame 10. Preferably, the sandwiched flange portion of the fabric filter medium 12, and the upper and lower plates 14, 16 of the support frame 10, are adhesively joined together to form an integral, unitary structure that has a minimal thickness so as not to significantly raise the height of the grate 2 relative to the surrounding paved roadway or surface when the filtering apparatus 8 of the present invention is installed in a storm drain 4.

More specifically, it is an industry standard that the storm grate 2 cannot be raised more than 0.125 inches with the filter apparatus installed. The challenging part of the design was finding a way to attach the filter medium 12 to the frame 10 without attachment hardware (e.g., clips, rivets, screws, etc.) that would result in a frame thickness greater than 0.125 inches. The solution turned out to be using an adhesive that can survive the rigors of a storm drain environment to join the filter medium 12 to the frame 10 to form a low profile, rigid assembly of frame sections (i.e., the upper and lower plates 14, 16) and filter medium 12. Once the filtering apparatus 8 of the present invention is installed in a storm drain 4, the flexible geotextile filter material will conform to most internal storm drain irregularities or impediments.

In a preferred form of the present invention, and as shown in FIGS. 2-5, 13 and 14, the filtering apparatus 8 of the present invention includes lifting straps 42 attached directly to the filter medium 12, preferably at the four corners of the side walls 28-34 near the upper sections thereof and extending upwardly therefrom. The straps 42 are provided directly on the filter medium 12 and preferably do not pass through the support frame 10 so as not to bend or overstress the thin metal frame 10 when removing the filtering apparatus 8 full of debris from the grate opening 6 of the storm drain 4. The straps 42 may be made from Nylon or fabric, or other material, and each strap 42 is preferably formed with a loop 44 at its free end. The straps 42 are easily graspable by roadway workers to remove the frame 10 and fabric filter basket 12 from the storm drain 4 for cleaning or replacement.

In yet another preferred form of the filtering apparatus 8 of the present invention, screened bypass windows 46 are sewn into or otherwise formed in one, two, three or all four side walls 28-34 of the filter basket 12 at upper sections thereof to allow stormwater to exit therethrough given an unusually heavy rainfall event.

FIGS. 15-17 illustrate a second form of a filtering apparatus 8 constructed in accordance with the present invention and particularly adapted for use with storm drains 4 having a circular grate frame 5 and ledge 7 and a circular grate 2. In this second form, the support frame 10 is planar and circular in shape and is defined by a planar, ring-like upper plate 14 and a planar, ring-like lower plate 16 disposed below and in close proximity to the upper plate 14, the upper and lower plates 14, 16 of the support frame 10 being preferably formed from sheet metal, stainless steel or aluminum alloy and having the same or similar dimensions.

The support frame 10 of this second form of the filtering apparatus 8 of the present invention defines a central opening 26, which is preferably circular but which could be rectangular, oval or another shape. As will be described below, the support frame 10, defined by the upper and lower plates 14, 16, supports a filter medium 12 preferably in the shape of a cylindrical sack (or a rectangular basket, as in the first embodiment shown in FIGS. 2-14) for catching sediment or debris carried by stormwater passing through the grate 2 of a storm drain 4. The filter medium 12 hangs below the support frame 10 in the circular opening 26 thereof, and is supported thereby.

Like with first embodiment of the filtering apparatus 8 shown in FIGS. 2-14, the filter medium 12 of this second form of the filtering apparatus 8 of the present invention is preferably formed from a woven geotextile fabric, such as Part No. GTF-117F, as described previously. The filter medium 12 is preferably generally cylindrical in shape, defined by a cylindrical side wall 48 and a bottom wall 50, the side wall 48 and the bottom wall 50 being joined together, and having a preferably circular top opening 52. The filter medium 12 of this second embodiment of the filtering apparatus 8, just like with the previously described embodiment of the filtering apparatus 8 of the present invention shown in FIGS. 2-14, may be formed from other materials, such a thermoplastic, water permeable material, and exhibit shapes other than cylindrical.

The fabric filter medium 12 of this second form of the filtering apparatus 8 of the present invention preferably includes an integrally formed fabric flange 40 which surrounds the cylindrical side wall 48 of the medium 12 at the upper portion thereof about the top opening 52 and extends outwardly therefrom. The flange 40 may be defined as an outwardly extending flap forming an extended upper section of the cylindrical side wall 48. The flange 40 is received by, and is sandwiched between, the upper and lower plates 14, 16 of the support frame 10, with the top opening 52 of the filter medium 12 being situated in alignment with the central opening 26 of the support frame 10. Preferably, the sandwiched flange portion 40 of the fabric filter medium 12, and the upper and lower plates 14, 16 of the support frame 10, are adhesively joined together to form an integral, unitary structure that has a minimal thickness, which is preferably no more than 0.125 inches, so as not to significantly raise the height of the grate 2 relative to the surrounding paved roadway or surface when the filtering apparatus 8 of the present invention is installed in a storm drain 4, in the same way as the first embodiment of the filtering apparatus 8 of the present invention described previously and shown in FIGS. 2-14 of the drawings. As with the first embodiment, using an adhesive to join the filter medium 12 to the frame 10 of the filtering apparatus 8 of this second embodiment of the present invention shown in FIGS. 15-17 of the drawings forms a low profile, rigid assembly of frame sections (i.e., the upper and lower plates 14, 16) and filter medium 12. Once this second form of the filtering apparatus 8 of the present invention is installed in a storm drain 4, the flexible geotextile filter material will conform to most internal storm drain irregularities or impediments.

Just like in the first embodiment of the filtering apparatus 8, the filtering apparatus 8 of this second form preferably includes lifting straps 42 attached directly to the filter medium 12 at the upper section of the cylindrical side wall 48 about the top opening 52 and extending upwardly from the filter medium 12, adjacent straps 42 preferably being spaced apart from each other a predetermined distance about the circumference of the cylindrical side wall 48. FIGS. 15-17 show, by way of example only, four straps 42 attached to the filter medium 12, adjacent straps 42 being spaced apart from each other by ninety (90) degrees about the periphery of the top opening 52, but fewer or more lifting straps 42 than four may be attached to the filter medium 12. Just like with the first embodiment of the filtering apparatus 8, the straps 42 of this second embodiment are provided directly on the filter medium 12 and preferably do not pass through the support frame 10 so as not to bend or overstress the thin metal frame 10 when removing the filtering apparatus 8 full of debris from the grate opening 6 of the storm drain 4. As previously stated, the straps 42 may be made from Nylon or fabric, or other material, and each strap 42 is preferably formed with a loop 44 at its free end, just like in the first embodiment, so that the straps 42 may be easily grasped by roadway workers to remove the frame 10 and fabric filter basket 12 from the storm drain 4 for cleaning or replacement.

This second version of the filtering apparatus 8 of the present invention may include one or more screened bypass windows 46 that are sewn into or otherwise formed in the cylindrical side wall 48 of the filter medium 12 at upper section thereof to allow stormwater to exit therethrough in the event of a heavy rainfall.

The filtering apparatus 8 of the present invention will now be further described.

A catch basin stormwater filtering apparatus 8 constructed in accordance with the present invention includes a support frame 10 and a filter medium 12 supported by the support frame 10. The support frame 10 includes a planar upper plate 14 and a planar lower plate 16 disposed below and in close proximity to the upper plate 14, the support frame 10 defining a central opening 26. The filter medium 12 includes a bottom wall 36, 50 and one or more side walls 28-34, 48 joined to and extending from the bottom wall 36, 50, the one or more side walls 28-34, 48 defining a top opening 38, 52 situated opposite the bottom wall 36, 50, the top opening 38, 52 being disposed in alignment with the central opening 26 of the support frame 10. The filter medium 12 includes a flange 40 extending outwardly from the one or more side walls 28-34, 48 and at least partially surrounding the top opening 38, 52. The flange 40 of the filter medium 12 is interposed between the upper plate 14 and the lower plate 16 of the support frame 10 such that the filter medium 12 is joined to and supported by the support frame 10.

In one form, the filter medium 12 of the catch basin stormwater filtering apparatus 8 of the present invention is formed from a water permeable material. In another form, the filter medium 12 is formed from a woven geotextile fabric. In yet another form, the filter medium 12 is formed from a polypropylene fabric.

In yet another form of the present invention, the catch basin stormwater filtering apparatus 8 has the bottom wall 36, 50, flange 40 and the one or more side walls 28-34, 48 of the filter medium 12 formed from a woven geotextile material, and the flange 40 is an integrally formed extension portion of the one or more side walls 28-34, 48 of the filter medium 12.

In one form, the filter medium 12 of the catch basin stormwater filtering apparatus 8 of the present invention is generally cylindrically shaped, and the one or more side walls 28-34, 48 of the filter medium 12 include a cylindrically-shaped side wall 48 which surrounds the bottom wall 50 and the top opening 52.

In another form, the filter medium 12 of the catch basin stormwater filtering apparatus 8 of the present invention is generally shaped as a rectangular parallelepiped, and the one or more side walls 28-34, 48 of the filter medium 12 include four lateral side walls 28-34, the four lateral side walls 28-34 including adjacent side walls 28-34, the adjacent side walls 28-34 being joined together, the lateral side walls 28-34 being joined to the bottom wall 36 and together defining the top opening 38.

In one embodiment of the catch basin stormwater filtering apparatus 8 of the present invention, the upper plate 14 of the support frame 10, the lower plate 16 of the support frame 10 and the flange 40 of the filter medium 12 interposed between the upper plate 14 and the lower plate 16 are adhesively joined together to form an integral, unitary structure.

In yet another embodiment of the catch basin stormwater filtering apparatus 8 of the present invention, the upper plate 14 of the support frame 10, the lower plate 16 of the support frame 10 and the flange 40 of the filter medium 12 interposed between the upper plate 14 and the lower plate 16 together have a combined overall thickness which is substantially at most equal to one-eighth (⅛) inches.

In a further embodiment of the catch basin stormwater filtering apparatus 8 of the present invention, the support frame 10 is one of circular in shape and rectangular in shape.

In still another embodiment of the catch basin stormwater filtering apparatus 8 of the present invention, the filter medium 12 includes an upper portion disposed in proximity to the top opening 38, 52 of the filter medium 12, and a plurality of lifting straps 42 joined to the upper portion of the filter medium 12 and spaced apart from one another about the top opening 38, 52 of the filter medium 12. At least some of the straps 42 of the plurality of straps 42 of the filter medium 12 may have a free end and include a loop 44 formed at the free end thereof.

In a further embodiment of the catch basin stormwater filtering apparatus 8 of the present invention, the one or more side walls 28-34, 48 of the filter medium 12 include at least one water bypass window 46 formed through the thickness thereof. The filter medium 12 may include a screen which covers the at least one water bypass window 46.

The present invention is also directed to the combination of a storm vault 4 and a stormwater filtering apparatus 8 which is mountable in the storm vault 4. More specifically, the storm vault 4 has an upper portion and a grate frame 5 mounted on the upper portion of the storm vault 4. The grate frame 5 defines a grate opening 6. The storm vault 4 has an interior cavity which receives stormwater through the grate opening 6 defined by the grate frame 5. The grate frame 5 has a horizontal ledge 7, and a stormwater-receiving grate 2 removably supported by the grate frame 5 and being disposed in proximity to the horizontal ledge 7 of the grate frame 5. The stormwater-receiving grate 2 has outer dimensions.

The stormwater filtering apparatus 8 includes a support frame 10 and a filter medium 12 supported by the support frame 10. The support frame 10 includes a planar upper plate 14 and a planar lower plate 16 disposed below and in close proximity to the upper plate 14. The support frame 10 has outer dimensions, and defines a central opening 26.

The filter medium 12 includes a bottom wall 36, 50 and one or more side walls 28-34, 48 joined to and extending from the bottom wall 36, 50. The one or more side walls 28-34, 48 define a top opening 38, 52 situated opposite the bottom wall 36, 50, the top opening 38, 52 being disposed in alignment with the central opening 26 of the support frame 10. The filter medium 12 includes a flange 40 extending outwardly from the one or more side walls 28-34, 48 and at least partially surrounding the top opening 38, 52. The flange 40 of the filter medium 12 is interposed between the upper plate 14 and the lower plate 16 of the support frame 10 such that the filter medium 12 is joined to and supported by the support frame 10.

The support frame 10 of the stormwater filtering apparatus 8 is removably interposed between the horizontal ledge 7 of the grate frame 5 and the stormwater-receiving grate 2. Furthermore, the outer dimensions of the support frame 10 are substantially equal to the outer dimensions of the stormwater-receiving grate 2.

The several versions of the filtering apparatus 8 of the present invention described previously and shown in FIGS. 2-14 and FIGS. 15-17 of the drawings will fit securely under the steel grate 2 of an existing storm vault 4 without any significant increase in the height of the steel grate 2. The heavy steel grate 2 also by its weight exerts pressure on the support frame 10 of the filtering apparatus 8 to help maintain the proper position of the filtering apparatus 8 within the grate opening 6, with the support frame 10 wedged between the steel grate 2 and the basin ledge 7 on which the support frame 10 rests. The weight of the heavy steel grate 2 on the support frame 10 situated thereunder also helps prevent the relatively thin support frame 10 of the filtering apparatus 8 from deforming, especially under heavy stormwater or debris loads on the filter basket 12.

Additionally, the construction of the filtering apparatus 8 of the present invention is simplified by adhesively joining the upper and lower plates 14, 16 and filter medium 12 together without the use of fasteners and without significantly increasing the frame thickness, thereby meeting the general grate height restrictions for the installation of debris filters in existing storm drains 4.

Furthermore, the task placed on the municipality's department of public works or other agency in obtaining measurements needed by the filter manufacturer or installer is significantly reduced by the structure of the filtering apparatus 8 of the present invention. No measurement of the grate ledge 7 or removal of the grate 2 is required. The municipality's workers need only provide the outer dimensions of the grate 2 to the filter manufacturer so that the support frame 10 of the filtering apparatus 8 of the present invention may be fabricated with similar dimensions.

Although illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

What is claimed is:

1. A catch basin stormwater filtering apparatus, which comprises:
a support frame; and
a filter medium supported by the support frame;
wherein the support frame includes a planar upper plate and a planar lower plate disposed below and in close proximity to the upper plate, the support frame defining a central opening;
wherein the filter medium includes a bottom wall and one or more side walls joined to and extending from the bottom wall, the one or more side walls defining a top opening situated opposite the bottom wall, the top opening being disposed in alignment with the central opening of the support frame, the filter medium including a flange extending outwardly from the one or more side walls and at least partially surrounding the top opening; and
wherein the flange of the filter medium is interposed between the upper plate and the lower plate of the support frame such that the filter medium is joined to and supported by the support frame.

2. A catch basin stormwater filtering apparatus as defined by claim 1, wherein the filter medium is formed from a water permeable material.

3. A catch basin stormwater filtering apparatus as defined by claim 2, wherein the filter medium is formed from a woven geotextile fabric.

4. A catch basin stormwater filtering apparatus as defined by claim 3, wherein the filter medium is formed from a polypropylene fabric.

5. A catch basin stormwater filtering apparatus as defined by claim 3, wherein the bottom wall, flange and the one or more side walls of the filter medium are formed from the woven geotextile material; and
wherein the flange is an integrally formed extension portion of the one or more side walls of the filter medium.

6. A catch basin stormwater filtering apparatus as defined by claim 1, wherein the filter medium is generally cylindrically shaped; and
wherein the one or more side walls of the filter medium include a cylindrically-shaped side wall which surrounds the bottom wall and the top opening.

7. A catch basin stormwater filtering apparatus as defined by claim 1, wherein the filter medium is generally shaped as a rectangular parallelepiped; and
wherein the one or more side walls of the filter medium include four lateral side walls, the four lateral side walls including adjacent side walls, the adjacent side walls being joined together, the lateral side walls being joined to the bottom wall and together defining the top opening.

8. A catch basin stormwater filtering apparatus as defined by claim 1, wherein the upper plate of the support frame, the lower plate of the support frame and the flange of the filter medium interposed between the upper plate and the lower plate are adhesively joined together to form an integral, unitary structure.

9. A catch basin stormwater filtering apparatus as defined by claim 1, wherein the upper plate of the support frame, the lower plate of the support frame and the flange of the filter medium interposed between the upper plate and the lower plate together have a combined overall thickness which is substantially at most equal to one-eighth (⅛) inches.

10. A catch basin stormwater filtering apparatus as defined by claim 1, wherein the support frame is one of circular in shape and rectangular in shape.

11. A catch basin stormwater filtering apparatus as defined by claim 1, wherein the filter medium includes an upper portion disposed in proximity to the top opening of the filter medium, and a plurality of lifting straps joined to the upper portion of the filter medium and spaced apart from one another about the top opening of the filter medium.

12. A catch basin stormwater filtering apparatus as defined by claim 11, wherein at least some of the straps of the plurality of straps of the filter medium have a free end and include a loop formed at the free end thereof.

13. A catch basin stormwater filtering apparatus as defined by claim 1, wherein the one or more side walls of the filter medium include at least one water bypass window formed through the thickness thereof.

14. A catch basin stormwater filtering apparatus as defined by claim 13, wherein the filter medium includes a screen which covers the at least one water bypass window.

15. In combination:
a storm vault, the storm vault having an upper portion and a grate frame mounted on the upper portion of the storm vault, the grate frame defining a grate opening, the storm vault having an interior cavity which receives stormwater through the grate opening defined by the grate frame, the grate frame having a horizontal ledge, and a stormwater-receiving grate removably supported by the grate frame and being disposed in proximity to the horizontal ledge of the grate frame, the stormwater-receiving grate having outer dimensions; and
a stormwater filtering apparatus, the filtering apparatus including a support frame and a filter medium supported by the support frame;
wherein the support frame includes a planar upper plate and a planar lower plate disposed below and in close proximity to the upper plate, the support frame having outer dimensions, the support frame defining a central opening;
wherein the filter medium includes a bottom wall and one or more side walls joined to and extending from the bottom wall, the one or more side walls defining a top opening situated opposite the bottom wall, the top opening being disposed in alignment with the central opening of the support frame, the filter medium including a flange extending outwardly from the one or more side walls and at least partially surrounding the top opening;
wherein the flange of the filter medium is interposed between the upper plate and the lower plate of the support frame such that the filter medium is joined to and supported by the support frame;
wherein the support frame of the stormwater filtering apparatus is removably interposed between the horizontal ledge of the grate frame and the stormwater-receiving grate; and
wherein the outer dimensions of the support frame are substantially equal to the outer dimensions of the stormwater-receiving grate.
